(19) United States
(12) Patent Application Publication
(10) Pub. No.: US 2005/0195334 A1
(43) Pub. Date: Sep. 8, 2005

(54) METHOD AND RELATED CIRCUIT FOR DETECTING BLACK FRAMES IN VIDEO SIGNAL

(76) Inventors: Chia-Hung Yeh, Taipei City (TW); Hsuan-Huei Shih, Taipei City (TW); Chung-Chieh Kuo, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,470

(22) Filed: Jul. 14, 2004

(30) Foreign Application Priority Data
Feb. 18, 2004 (TW) 093103979

(51) Int. Cl. H04N 7/16

(52) U.S. Cl. 348/700; 725/22; 725/19; 382/181; 382/194; 382/205

(57) ABSTRACT

A method and related circuit for detecting black frames, which are inserted between normal programs and commercial spots in a broadcasting video signal. For a frame in the video signal, representative pixels are selected as reference pixels according to their positions in the frame, and whether the frame is black can be determined efficiently according to statistical properties of these reference pixels. For example, pixels aligned in a diagonal of a frame can be selected as reference pixels to determine if the frame is black. Also, the invention applies to frequency domain video signals. Blocks are selected as reference blocks according to their position in a frame, and whether the frame is black is determined according to low-frequency components of reference blocks.

### BACKGROUND OF INVENTION

1. Field of the Invention

The present invention provides a method for detecting commercial-spot frames, and more particularly, a method and related circuit for detecting black frames with a few but representative pixels.

2. Description of the Prior Art

Video programs from mass media provide news, knowledge, and entertainments for audiences. However, considering commercial pursuits, the programs are often alternated with commercials, which breaks coherence and wastes time. Therefore, how to filter out commercials within a video program becomes one of the most important issues for development in modern information technology

Please refer to FIG. 1, which illustrates a schematic diagram of a video signal 10. The motion (dynamic) video signal 10 includes parts of a program and commercials. The video signal 10 can be regarded as a combination of a series of frames each showing an image. Playing the frames with a proper frequency (frame rate) can show the dynamic video. In the video signal 10, the frames Fa1 to FaN, and Fd1 to FdQ are different parts of the program, while the frames Fb1 to FbM, and Fc1 to FcP are two commercial spots. In general, many countries have ruled that an interval between a part of the program and a commercial spot should be included in the video signal 10, so that a black frame sequence is introduced for separating the program from the commercial spot. This so-called a black frame is a full black frame, and combining such black frames forms a black frame sequence, such as sequences from frames B1a to B1b, frames B2a to B2b, and frames B3a to B3b shown in FIG. 1.

Therefore, as long as the black frames can be detected in the video signal 10, the separated program can be reconstructed into a whole program by filtering out the commercial spots. As those skilled in the art recognize, each frame can be regarded as a combination of a plurality of pixels each having a tint and a brightness. Pixels of a black frame are all (basically uniformly) black, so that differences between any two pixels of the black frame are quite little. As a result, a prior art detection method is to calculate a brightness mean and a brightness variance of the pixels of each frame for determining whether a frame is a black frame with small brightness mean and variance. However, the above method requires a lot of calculations and system resources, and so the efficiency of black frame detection is low.

Another prior art black frame detection method is to analyze histograms of all pixels of a frame, which sorts the pixels into different bins according to brightness of each pixel, and calculates a brightness mean and a brightness variance of the pixels in a low-brightness bin. Although this method only deals with the pixels in the low-brightness bin, it has to analyze histograms of all the pixels of the frame, equivalently calculating all the pixels. Therefore, the efficiency of black frame detection cannot be improved.

### SUMMARY OF INVENTION

It is therefore a primary objective of the claimed invention to provide a method and related circuit for detecting black frames.

According to the claimed invention, a method for detecting a black frame of a video signal includes: (a) receiving a frame data from the video signal. The frame data includes a plurality of pixel data each corresponding to a pixel of an image. (b) processing a setting step for setting a pattern including a plurality of reference positions. (c) processing a sampling step for determining reference pixels according to positions of the pixels in the image. A pixel of the image is determined as a reference pixel if the position of the pixel equals a reference position. The pattern limits the number of reference pixels to be smaller than the number of pixels of the image, and keeps the number of reference pixels from changing as the pixel data corresponding to the pixels of the image change; and (d) processing a decision step for determining whether the pixel data corresponding to the pixels of the image fit a default according to the pixel data corresponding to the reference pixels.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a schematic diagram of a prior art video signal.

FIG. 2 illustrates a block diagram of a processing circuit of the present invention.

FIG. 3 illustrates a frame data diagram of the processing circuit in FIG. 2.

FIG. 4 illustrates a schematic diagram of the processing circuit in FIG. 2 when processing black frame detection.

FIG. 5 to FIG. 7 illustrate schematic diagrams of the processing circuit in FIG. 2 when selecting references pixels according to different patterns.

FIG. 8 illustrates a schematic diagram of a process of one-tier black frame detection.

FIG. 9 illustrates a schematic diagram of a process of multi-tier black frame detection.

FIG. 10 illustrates a schematic diagram of a processing circuit for detecting a black frame with frequency-domain data.

FIG. 11 illustrates a frame data diagram of the processing circuit in FIG. 10.

FIG. 12 illustrates a schematic diagram of the processing circuit in FIG. 10 when processing black frame detection.

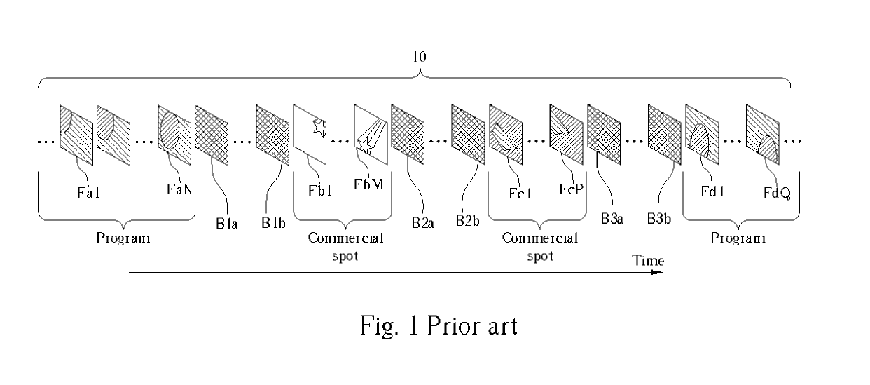

### DETAILED DESCRIPTION

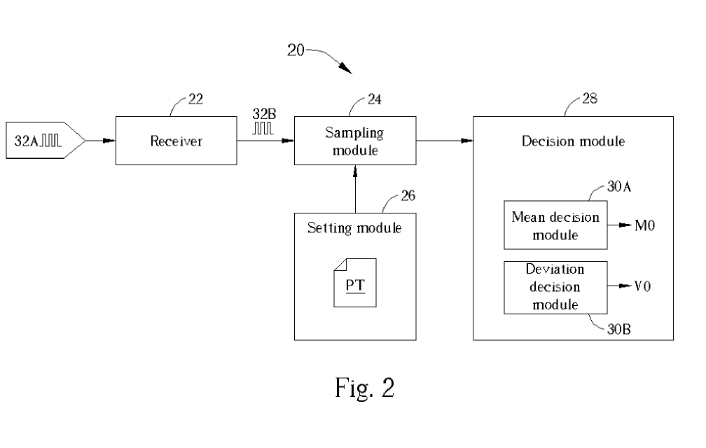

Please refer to FIG. 2, which illustrates a block diagram of a present invention processing circuit 20. The processing circuit 20 includes a receiver 22, a sampling module 24, a setting module 26, and a decision module 28. The receiver 22 includes decoding and demodulation circuits for drawing a video signal 32B out from a signal 32A. The signal 32A is provided by a mass media or a storage device (such as a VCD-player, DVD-player or a hard disk), while the video signal 32B includes a plurality of frame data each corresponding to a frame. The setting module 26 stores one or more patterns PT each corresponding to a plurality of reference positions. When detecting each frame in the video signal 32B, the sampling module 24 samples a frame according to the patterns PT, so as to determine reference pixels, which are the pixels of the frame having positions matching the reference positions. The decision module 28 can determine whether the frame is a black frame based on statistic characters of the reference pixels. In a preferred embodiment, the decision module 28 includes a mean decision module 30A and a deviation decision module 30B for calculating a mean M0 and a deviation V0 (or a variance) according to the reference pixels, so as to determine the black frame with the mean M0 and the deviation V0.

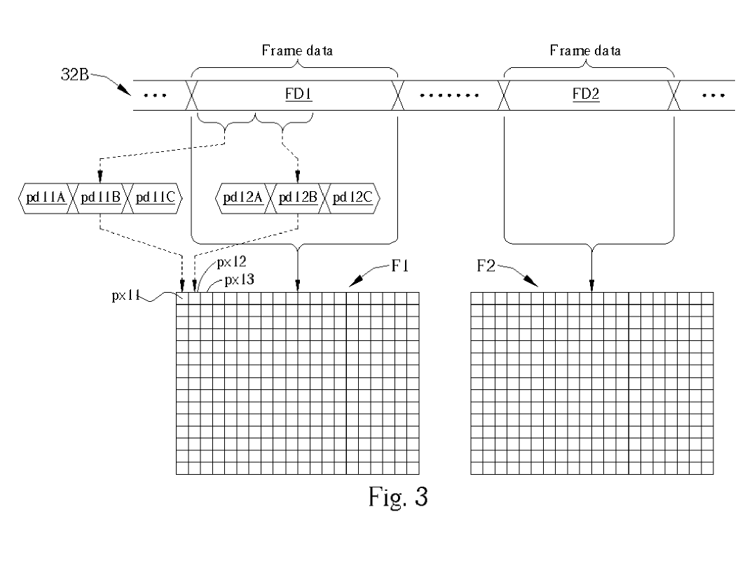

Please refer to FIG. 3 (also FIG. 2), which illustrates a timing diagram of the signals of the processing circuit 20. As mentioned above, the video signal 32B includes frame data FD1, FD2, etc. corresponding to frames F1, F2, etc. Each frame data includes a plurality of pixel data for recording corresponding information, such as tint, brightness, etc. For example, the frame F1 includes pixels px11, px12, px13, etc, and accordingly, the frame data FD1 includes pixel data pd11A, pd11B, and pd11C for describing the tint and brightness of the pixel px11, and pixel data pd12A, pd12B, pd12C for describing the pixel px12. That is, the pixel data pd11A, pd11B, and pd11C are RGB (red, green, blue) quantities if the video signal 32B is defined by RGB, or the pixel data pd11A, pd11B, and pd11C are Y, RY, BY signals if the video signal 32B is defined chromatically.

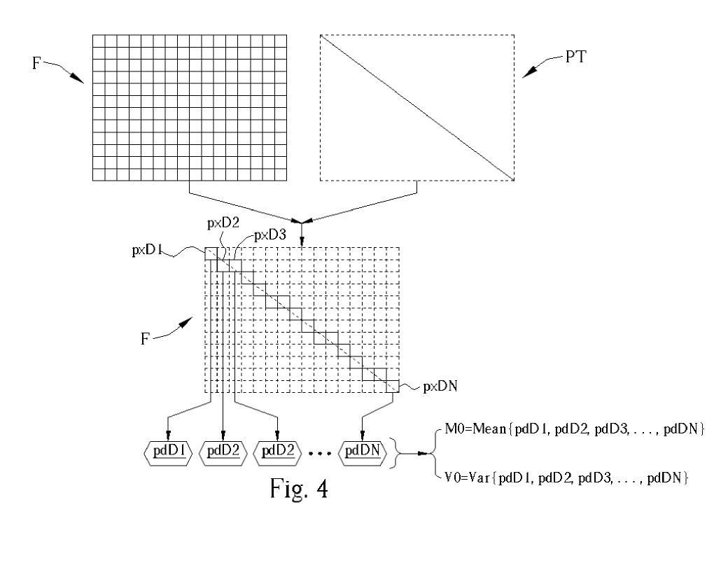

Please refer to FIG. 4 (also FIG. 2), which illustrates a schematic diagram of the present invention when processing the black frame detection. The pattern PT stored in the setting module 26 is diagonal. When the processing circuit 20 determines whether a frame F of the video signal 32B is a black frame, the sampling module 24 selects pixels pxD1, pxD2, pxD3 to pxDN as reference pixels according to diagonal of the pattern PT, and reads pixel data (such as brightness signals Y of the reference pixels) pdD1, pdD2, pdD3 to pdDN from the video signal 32B. Then, the mean decision module 30A of the decision module 28 calculates a mean M0 according to the pixel data pdD1 to pdDN, while the deviation decision module 30B calculates a deviation V0 for determining a deviation degree of each pixel data from the mean M0, such as a variance.

After calculating the mean M0 and the deviation V0, the decision module 28 determines that the frame F is a black frame if the mean M0 and the deviation V0 are smaller than a threshold mean and a threshold deviation meaning that the reference pixels pxD1 to pxDN are low brightness, and vary little.

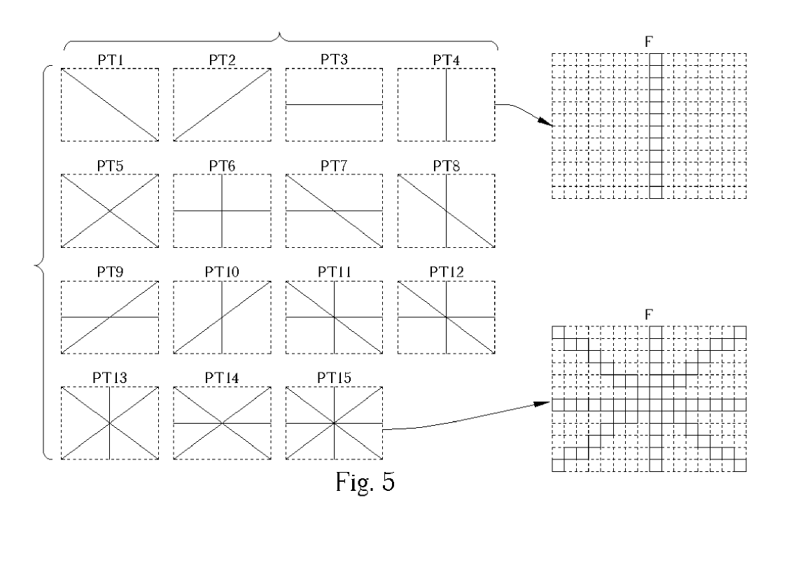

As those skilled in the art should recognize, as long as the pattern PT includes both sides and the middle of the frame F, the sampling module 24 can determine enough pixels to represent the frame F. Please refer to FIG. 5 (also FIG. 2), which illustrates a plurality of embodiments of the pattern PT, labeled as PT1 to PT15. Lines of the patterns PT1 to PT15 shows positions of the reference pixels, such as diagonals, crosscuts, midlines, or their combinations. Take the patterns PT4 and PT15 for example; the sampling module 24 selects the reference pixels along the midline of the frame F according to the pattern PT4, or along the midline, crosscut, and two diagonals of the frame F according to the pattern PT15. Therefore, the reference pixels selected from a frame are fewer than the exact pixels of the frame, but enough to represent the frame, so that efficiency of black frame detection can be increased.

In addition, the above-mentioned threshold mean and deviation can be dynamically changed as the frame changes. For example, after the reference pixels are determined, the present invention can set the threshold mean according to each pixel data of the reference pixels, such as the 70% value of the maximum pixel data, or the difference between the maximum and the minimum pixel data.

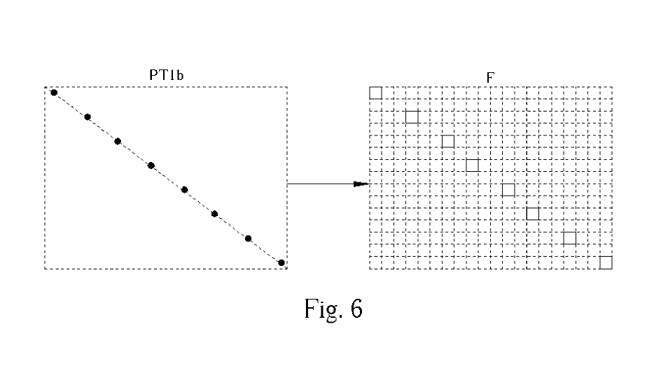

Please refer to FIG. 6, which illustrates a schematic diagram of a pattern PT1b. The pattern PT1b derived from the pattern PT1 in FIG. 5 locates pixel positions in the diagonal of a frame with a specific interval, so as to determine black frames with fewer reference pixels. Basically, the patterns PT1 to PT15 in FIG. 5 can derive such advanced sampling with specific intervals.

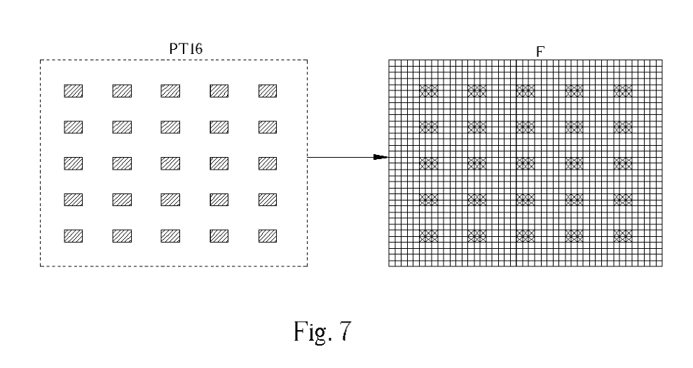

Other than the linear patterns in FIG. 4 to FIG. 6, please refer to FIG. 7, which illustrates a schematic diagram of a pattern PT16. The pattern PT16 indicates the reference positions with a plurality of uniform spread rectangles (as hatched areas shown in FIG. 7), so that the sampling module 24 selects the reference pixels from the frame F according to the rectangles of the pattern PT16 as intersection areas shown in FIG. 7. Certainly, with changing the size of each rectangle of the pattern PT16, other patterns can be derived from the pattern PT16, such as a derivational pattern having uniform spread rectangles each corresponding to only one pixel.

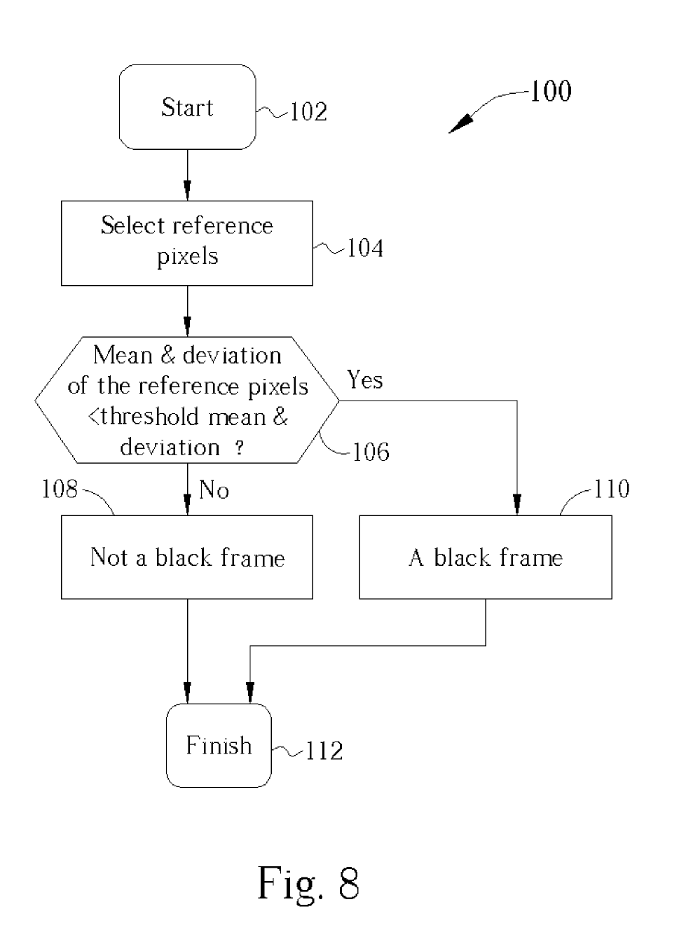

Please refer to FIG. 8, which illustrates a flowchart of a process 100 of black frame detection. The process 100 includes the following steps:

Step 102: start a black frame detection.

Step 104: select reference pixels from a frame F according to a first pattern.

Step 106: calculate statistic characters of the reference pixels, such as a mean and a deviation, and determining whether the mean and the deviation are smaller than a threshold mean and a threshold deviation. If true, the process 100 proceeds to step 110, otherwise it proceeds to step 108.

Step 108: the frame F is not a black frame.

Step 110: the frame F is a black frame.

Step 112: finish.

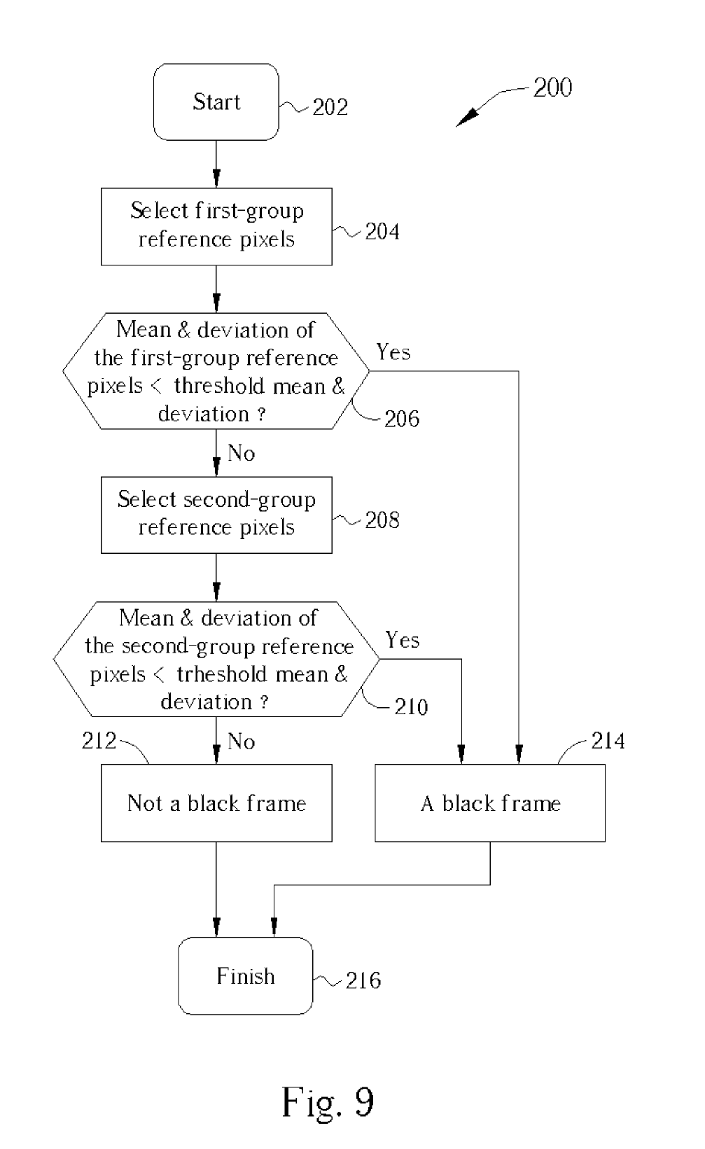

Please refer to FIG. 9, which illustrates a flowchart of a two-tier black frame detection of a process 200. The process 200 is different from the process 100, which is so-called a one-tier black frame detection. The process 200 includes the following steps:

Step 202: start a two-tier black frame detection.

Step 204: select reference pixels (designated as first-group reference pixels) from a frame F according to a first pattern.

Step 206: calculate statistic characters of the first-group reference pixels, such as a mean and a deviation (first-group mean and deviation), and determine whether the first-group mean and the first-group deviation are smaller than a threshold mean and a threshold deviation. If true, the process 200 proceeds to step 214, otherwise it proceeds to step 208.

Step 208: select reference pixels (designated as second-group reference pixels) from the frame F according to a second pattern. The second pattern can include more reference pixels than the first pattern, so as to calculate the statistic characters more accurately.

Step 210: calculate statistic characters of the second-group reference pixels, such as a mean and a deviation (second-group mean and deviation), and determine whether the second-group mean and the second-group deviation are smaller than a threshold mean and a threshold deviation. If true, the process 200 proceeds to step 214, otherwise it proceeds to step 212.

Step 212: the frame F is a black frame.

Step 214: the frame F is not a black frame.

Step 216: finish.

The process 200 can be compatible with the process 100 if the process 200 proceeds to step 212 rather than step 208 in step 206 when the first-group mean and the first-group deviation are not smaller than the threshold mean and the threshold deviation. In addition, the threshold mean and the threshold deviation in step 212 can be different from those in step 206. Other than the two-tier detection, three or more tier detection can also be derived from FIG. 8 and FIG. 9.

As those skilled in the art should recognize, in order to decrease transmission bandwidth and storage space for a video signal, MPEG (Motion Picture Experts Group) compression protocol, for example, is utilized, so that each frame of the video signal is divided into a plurality of blocks (each block includes 8*8 pixels, for example) each undergoing a frequency-domain transformation (such as two-dimensional discrete cosine transformation), so as to transform the pixel data of each block into data in the frequency domain. Then, a compressed video signal is generated by taking a variable length coding for the data in the frequency domain. Oppositely, when decompressing the compressed video signal, the data in the frequency domain is decoded with a variable length decoding for an inverse frequency-domain transformation (such as two-dimensional discrete cosine inverse transformation) into the pixel data, so as to reconstruct the original frame. The present invention can detect a black frame after the variable length decoding, but before the inverse frequency-domain transformation.

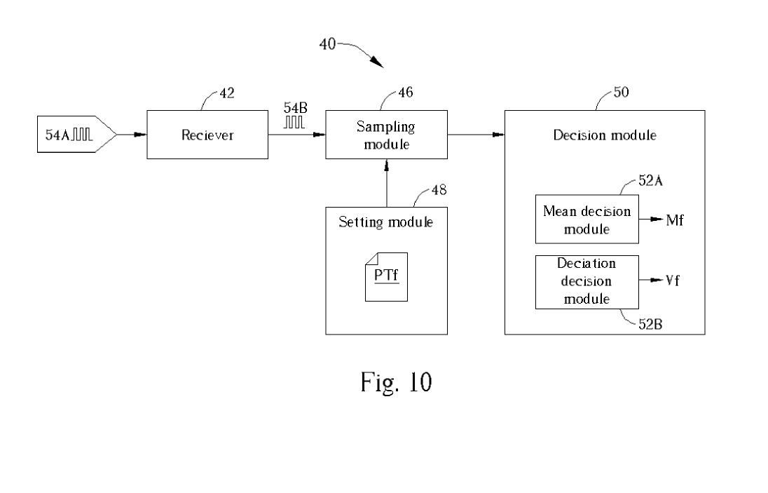

Please refer to FIG. 10, which illustrates a schematic diagram of a processing circuit 40. The processing circuit 40 includes a receiver 42, a sampling module 46, a setting module 48, and a decision module 50. The receiver 42 includes a decoding circuit for extracting a frequency-domain video signal 54B, which stores the data in the frequency domain of each block, from a compressed signal 54A. The setting module 48 stores one or more patterns PTf for the sampling module 46 to select the reference blocks from a frame, while the decision module 50 calculates statistic characters according to the data in the frequency domain (especially the low-frequency data or direct current data) corresponding to the reference blocks for determining whether the frame is a black frame. In addition, the decision module 50 can include a mean decision module 52A and a deviation decision module 52B for calculating a mean Mf and a deviation Vf according to the data corresponding to the reference blocks.

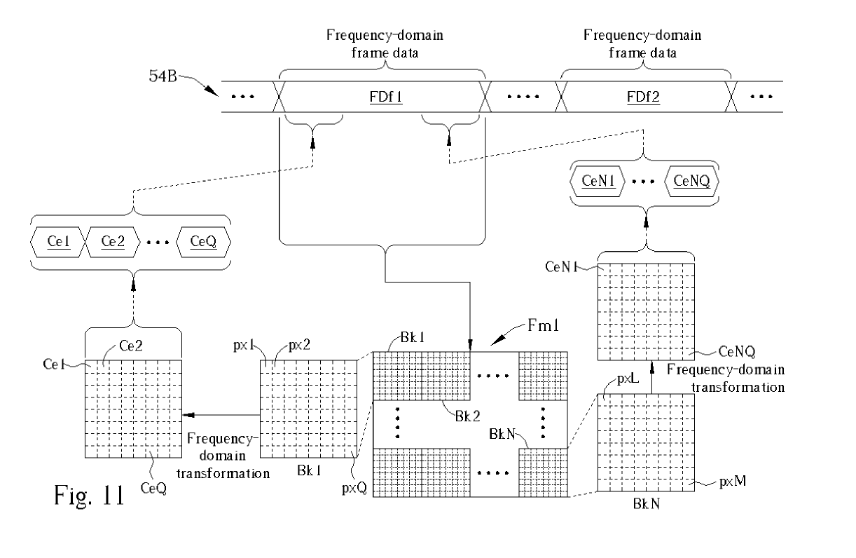

Please refer to FIG. 11 (also FIG. 10), which illustrates a timing diagram of signals of the processing circuit 40. The video signal 54B includes a plurality of frequency-domain frame data FDf1, FDf2, etc. each capable of being transformed into a frame. In FIG. 11, a frame Fm1 corresponding to the frequency-domain frame data FDf1 includes a plurality of blocks Bk1, Bk2 to BkN each including a plurality of pixels arranged in a matrix. As mentioned above, each pixel data corresponding to a pixel of a block will undergo a frequency-domain transformation, so that frequency-domain data Ce1, Ce2 to CeQ stored in the frequency-domain frame data FDf1 are obtained after transforming the pixel data of the block Bk1 into the frequency domain. Similarly, frequency-domain data CeN1 to CeNQ are obtained after transforming the pixel data of the block BkN into the frequency domain.

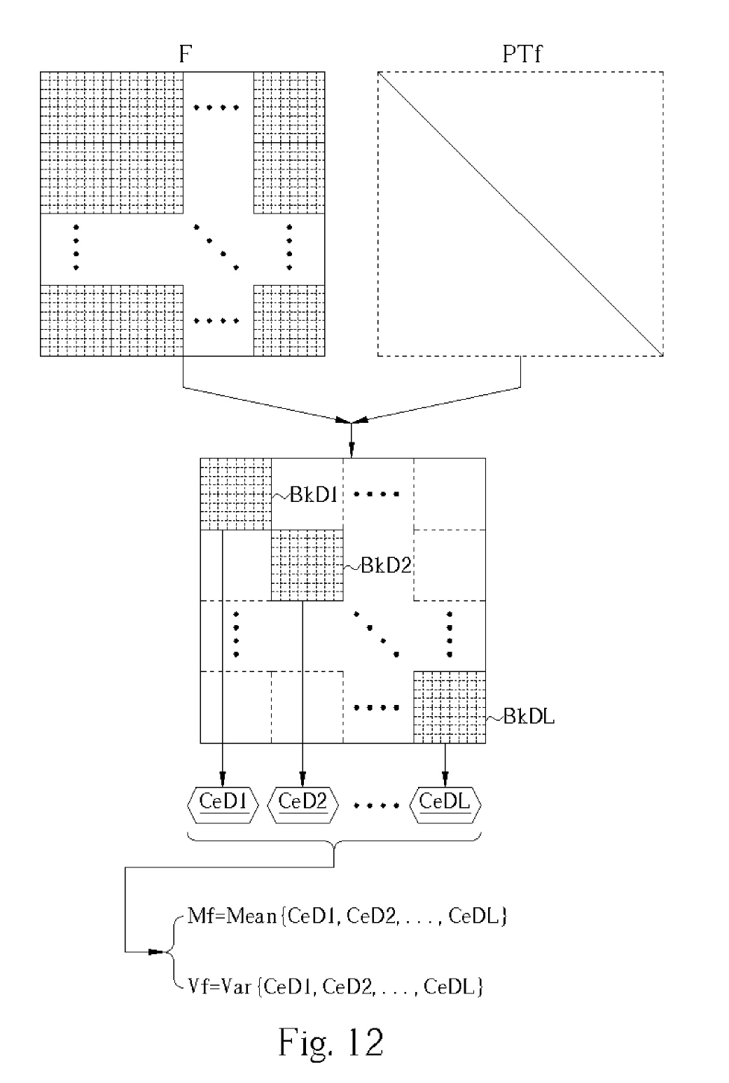

Please refer to FIG. 12 (also FIG. 10), which illustrates a schematic diagram of the present invention when detecting the black frame according to the frequency-domain frame data of a frame F. The sampling module 46 selects blocks BkD1 to BkDL as the reference blocks according to the diagonal of a pattern PTf, and draws direct-current data CeD1 to CeDI from the blocks BkD1 to BkDL. Then, the decision module 50 calculates the character statistics (such as the mean Mf and the deviation Vf) of the direct-current data CeD1 to CeDI, so as to determine whether the frame F is a black frame. For example, if the mean Mf is smaller than a threshold mean and the deviation Vf is smaller than a threshold deviation, the frame F is a black frame. Also, the deviation Vf in FIG. 10 can be obtained by an absolute value calculation.

When taking frequency-domain transformation of pixel data of each pixel of a block, the pixel data are multiplied by different weights, equivalently. Particularly, the direct-current data are summaries of the pixel data of the blocks. Therefore, the direct-current data corresponding to a reference block corresponds to the summary of the pixel data corresponding to the reference block. In other words, with statistic characters of direct-current data corresponding to the reference blocks, the black frame can be detected according to the mean and the deviation of the direct-current data.

In addition, when detecting the black frame with the frequency-domain transformation, the patterns in FIG. 5, FIG. 6, and FIG. 7 can be used, and so can the multi-tier detection of FIG. 9.

When detecting the black frame, the prior art uses much system resources for calculating all pixels of each frame, but the present invention is based on a few reference pixels enough to represent a frame. Therefore, the present invention can increase the efficiency of black frame detection and decrease the demand on system resources. Besides, the processing circuit of FIG. 2 or FIG. 10 can be implemented with hardware, software, or firmware.

Those skilled in the art will readily observe that numerous modifications and alterations of the device may be made while retaining the teachings of the invention. Accordingly, the above disclosure should be construed as limited only by the metes and bounds of the appended claims.

1. A method for detecting a black frame of a video signal comprising:
receiving a frame data from the video signal; the frame data comprising a plurality of pixel data each corresponding to a pixel of an image;
processing a setting step for setting a pattern comprising a plurality of reference positions;
processing a sampling step for determining reference pixels according to positions of the pixels in the image;
a pixel of the image is determined as a reference pixel if the position of the pixel equals a reference position; the pattern limiting the number of reference pixels to be smaller than the number of pixels of the image, and keeping the number of reference pixels from changing as the pixel data corresponding to the pixels of the image change; and
processing a decision step for determining whether the pixel data corresponding to the pixels of the image fit a default according to the pixel data corresponding to the reference pixels.

2. The method of claim 1 wherein the decision step comprises:
determining a mean and a deviation according to the pixel data corresponding to the reference pixels, the mean being an average of the pixel data corresponding to the reference pixels, the deviation being a difference between the pixel data corresponding to a reference pixel and the mean; and
determining whether the pixel data corresponding to pixels of the frame fit the default according to the mean and the deviation.

3. The method of claim 1 or claim 2 wherein the default is a data range for a pixel of the image to appear at low brightness.

4. The method of claim 2 wherein the deviation is determined according to an absolute value between the pixel data corresponding to each reference pixel and the mean.

5. The method of claim 2 wherein when processing the decision step, if the mean is smaller than a threshold mean and the deviation is smaller than a threshold deviation, the pixel data corresponding to the pixels of the image are determined to fit the default.

6. The method of claim 1 wherein the image comprises a plurality of pixels arranged in a matrix; the sampling step determining the plurality of reference pixels along the diagonal of the matrix.

7. The method of claim 1 wherein the image comprises a plurality of pixels arranged in a matrix; the sampling step determining the plurality of reference pixels along a column or a row of the matrix.

8. The method of claim 1 wherein the image comprises a plurality of pixels arranged in a matrix; the sampling step determining the plurality of reference pixels with a plurality of sub-matrixes of the matrix, the number of pixels of each sub-matrix is smaller than the number of pixels of the matrix.

9. The method of claim 1 further comprising:
after processing the decision step, processing a second sampling step for determining a plurality of second reference pixels from the pixels of the image if the pixel data corresponding to the pixels of the image do not fit the default; and
processing a second decision step for determining whether the pixel data corresponding to the pixels of the image fit the default according to the plurality of pixel data corresponding to the second reference pixels.

10. The method of claim 9 wherein the number of second reference pixels is greater than the number of first reference pixels.

11. A method for detecting a black frame of a video signal, the video signal comprising a plurality of frame data in the frequency domain, the method comprising:
receiving the frame data in the frequency domain from the video signal; the frame data in the frequency domain corresponding to an image, the image comprising a plurality of blocks each comprising a plurality of pixels comprising corresponding pixel data; wherein the frame data in the frequency domain comprises a plurality of low-frequency data each corresponding to a block of the image;
processing a setting step for setting a pattern comprising a plurality of reference positions;
processing a sampling step for determining reference blocks according to positions of the blocks in the image;
a block of the image is determined as a reference block if the position of the block equals a reference position;
the pattern limiting the number of reference blocks to be smaller than the number of pixels of the image; and
processing a decision step for determining whether the pixel data corresponding to the pixels of the image fit a default according to the low-frequency data corresponding to the reference blocks.

12. The method of claim 11 wherein the decision step comprises:
determining a mean and a deviation according to the low-frequency data corresponding to the reference blocks, the mean being an average of the low-frequency data corresponding to the reference blocks, the deviation being a difference between the low-frequency data corresponding to a reference block and the mean; and
determining whether the pixel data corresponding to pixels of the frame fit the default according to the mean and the deviation.

13. The method of claim 11 or claim 12 wherein the default is a data range for a pixel of the image to appear at low brightness.

14. The method of claim 12 wherein the deviation is determined according to an absolute value between the low-frequency data corresponding to each reference block and the mean.

15. The method of claim 12 wherein when processing the decision step, if the mean is smaller than a threshold mean and the deviation is smaller than a threshold deviation, the pixel data corresponding to the pixels of the image are determined to fit the default.

16. The method of claim 11 wherein the image comprises a plurality of blocks arranging in a matrix; the sampling step determining the plurality of reference blocks along the diagonal of the matrix.

17. The method of claim 11 wherein the image comprises a plurality of blocks arranging in a matrix; the sampling step determining the plurality of the reference blocks along a column or a row of the matrix.

18. A processing circuit for detecting a black frame of a video signal, the video signal comprising a plurality of frame data, the processing circuit comprising:
a receiver for receiving a frame data from the video signal; the frame data comprising a plurality of pixel data each corresponding to a pixel of an image;
a setting module for setting a pattern, the pattern comprising a plurality of reference positions;
a sampling module for determining reference pixels according to positions of the pixels in the image; a pixel of the image is determined as a reference pixel if the position of the pixel equals a reference position; the pattern limiting the number of reference pixels to be smaller than the number of pixels of the image, keeping the number of reference pixels from changing as the pixel data corresponding to the pixels of the image change; and
a decision module for determining whether the pixel data corresponding to the pixels of the image fit a default according to the pixel data corresponding to the reference pixels.

19. The processing circuit of claim 18 wherein the decision module comprises:
a mean decision module for determining a mean according to the pixel data corresponding to the reference pixels, the mean being an average of the pixel data corresponding to the reference pixels; and
a deviation decision module for determining a deviation according to the pixel data corresponding to the reference pixels, the deviation being a difference between the pixel data corresponding to a reference pixel and the mean; and
wherein the decision module determines whether the pixel data corresponding to pixels of the frame fit the default according to the mean and the deviation.

20. The processing circuit of claim 18 or claim 19 wherein the default is a data range for a pixel of the image to appear at low brightness.

21. The processing circuit of claim 19 wherein the deviation decision module determines the deviation according to an absolute value between the pixel data corresponding to each reference pixel and the mean.

22. The processing circuit of claim 19 wherein if the mean is smaller than a threshold mean and the deviation is smaller than a threshold deviation, the decision module determines that the pixel data corresponding to the pixels of the image fits the default.

23. The processing circuit of claim 18 wherein the image comprises a plurality of pixels arranged in a matrix; the sampling module determining the plurality of reference pixels along the diagonal of the matrix.

24. The processing circuit of claim 18 wherein the image comprises a plurality of pixels arranged in a matrix; the sampling module determining the plurality of reference pixels along a column or a row of the matrix.

25. The processing circuit of claim 18 wherein the image comprises a plurality of pixels arranged in a matrix; the sampling module determining the plurality of reference pixels with a plurality of sub-matrixes of the matrix, the number of pixels of each sub-matrix is smaller than the number of pixels of the matrix.

26. The processing circuit of claim 18 wherein if the pixel data corresponding to the pixels of the image do not fit the default, the decision module determines a plurality of second reference pixels from the pixels of the image; the decision module determining whether the pixel data corresponding to the pixels of the image fit the default according to the plurality of the pixel data corresponding to the second reference pixels.

27. The processing circuit of claim 26 wherein the number of second reference pixels is greater than the number of first reference pixels.

28. A processing circuit for detecting a black frame of a video signal, the video signal comprising a plurality of frame data in the frequency domain, the processing circuit comprising:
a receiver for receiving a frame data in the frequency domain from the video signal; the image comprising a plurality of blocks each comprising a plurality of pixels comprising corresponding pixel data; wherein the frame data in the frequency domain comprises a plurality of low-frequency data each corresponding to a block of the image;
a setting module for setting a pattern, the pattern comprising a plurality of reference positions;
a sampling module for determining reference blocks according to positions of the blocks in the image; a block of the image is determined as a reference block if the position of the block equals a reference position; the pattern limiting the number of reference blocks to be smaller than the number of pixels of the image; and
a decision module for determining whether the pixel data corresponding to the pixels of the image fit a default according to the low-frequency data corresponding to the reference blocks.

29. The processing circuit of claim 28 wherein the default is a data range for a pixel of the image to appear at low brightness.

30. The processing circuit of claim 28 wherein the decision module comprises:
a mean decision module for determining a mean according to the low-frequency data corresponding to the reference blocks, the mean being an average of the low-frequency data corresponding to the reference blocks; and
a deviation decision module for determining a deviation according to the low-frequency data corresponding to the reference blocks, the deviation being a difference between the low-frequency data corresponding to a reference block and the mean; wherein the decision module determines whether the pixel data corresponding to pixels of the frame fit the default according to the mean and the deviation.

31. The processing circuit of claim 30 wherein the default is a data range for a pixel of the image to appear at low brightness.

32. The processing circuit of claim 30 wherein the deviation decision module determines the deviation according to an absolute value between the low-frequency data corresponding to each reference block and the mean.

33. The processing circuit of claim 30 wherein if the mean is smaller than a threshold mean and the deviation is smaller than a threshold deviation, the decision module determines that the pixel data corresponding to the pixels of the image fits the default.

34. The processing circuit of claim 28 wherein the image comprises a plurality of blocks arranged in a matrix; the sampling module determining the plurality of the reference blocks along the diagonal of the matrix.

35. The processing circuit of claim 28 wherein the image comprises a plurality of blocks arranged in a matrix; the sampling module determining the plurality of the reference blocks along a column or a row of the matrix.
